(19) United States
(12) Patent Application Publication
(10) Pub. No.: US 2016/0050035 A1
(43) Pub. Date: Feb. 18, 2016

(54) WIRELESS RECEIVER WITH SIGNAL PROFILER MONITORING SIGNAL POWER PER FREQUENCY BAND

(71) Applicant: Texas Instruments Incorporated, Dallas, TX (US)

(72) Inventors: Hunsoo Choo, Plano, TX (US); Hamid Safiri, Plano, TX (US); Nikolaus Klemmer, Dallas, TX (US)

(21) Appl. No.: 14/824,062

(22) Filed: Aug. 11, 2015

Related U.S. Application Data
(60) Provisional application No. 62/035,827, filed on Aug. 11, 2014.

(51) Int. Cl. H04B 17/21; H04B 17/318; H04B 17/23

(52) U.S. Cl. CPC H04B 17/21; H04B 17/23; H04B 17/318

(57) ABSTRACT

A signal profiler generates and monitors a signal profile corresponding to signal power (absolute or relative) per frequency band. The signal profiler includes a signal profile generator and a signal profile monitor. The signal profile generator processes a received signal in pre-defined frequency bands, and captures frequency-band signal power information into frequency bins, this frequency-binned signal power information constituting a signal profile. The signal profile monitor monitors the signal profile, including variations in the signal profile based on pre-defined criteria, and output corresponding profile-variation information (such as flags or interrupt requests). The signal profile generator is an FFT engine. The signal profile monitor is an FSM (finite state machine). An example application is use in a direct conversion wireless receiver to monitor relative image channel power as a signal profile variation that can be used to invoke QMC compensation/configuration.

### CROSS-REFERENCE TO RELATED APPLICATIONS

Priority is claimed under USC §119(e) to U.S. Provisional Application 62/035,827 (Docket TI-75236PS), filed 11 Aug. 2014).

### BACKGROUND

Technical Field. This Patent Disclosure relates generally wireless/radio receivers.

Related Art. Wireless/Radio receivers down-convert incoming RF to baseband to retrieve the desired signal.

Signal processing is actively used to enhance signal quality, and minimize the non-ideal impairments of the receive path. Examples include AGC (automatic gain control), filtering, DC offset compensation and IQ mismatch/imbalance compensation (QMC).

Such active signal processing requires signal information to perform a particular signal processing operation, and/or to determine when such an operation is required. For example, some of signal processing operations like QMC rely on DSP algorithms running on MPU, but which cannot run continuously due to complexity.

RF receiver commonly provides peak and/or RMS detectors, which are not frequency dependent. The signal information collected from these detectors can be useful for AGC, but is much less so for tasks like IQ imbalance compensation, since frequency dependent information is not available.

### BRIEF SUMMARY

This Brief Summary is provided as a general introduction to the Disclosure provided by the Detailed Description and Drawings, summarizing aspects and features of the Disclosure. It is not a complete overview of the Disclosure, and should not be interpreted as identifying key elements or features of, or otherwise characterizing or delimiting the scope of, the disclosed invention.

The Disclosure describes a signal profiler monitoring signal power per frequency band, such as can be used in a wireless receiver.

According to aspects of the Disclosure, a signal profiler generates and monitors a signal profile corresponding to signal power (absolute or relative) per frequency band. The signal profiler includes a signal profile generator and a signal profile monitor. The signal profile generator processes a received signal in pre-defined frequency bands, and captures frequency-band signal power information into frequency bins, this frequency-binned signal power information constituting a signal profile. The signal profile monitor monitors the signal profile, including variations in the signal profile based on pre-defined criteria, and output corresponding profile-variation information (such as flags or interrupt requests). The signal profile generator is an FFT engine. The signal profile monitor is an FSM (finite state machine). An example application is use in a direct conversion wireless receiver to monitor relative image channel power as a signal profile variation that can be used to invoke QMC compensation/configuration.

Other aspects and features of the invention claimed in this Patent Document will be apparent to those skilled in the art from the following Disclosure.

### BRIEF DESCRIPTION OF THE DRAWINGS

FIG. 1 illustrates an example functional embodiment of a signal profiler, such as can be used in a wireless receiver, including an FFT signal profile generator (engine) that captures signal power (absolute and/or relative) per frequency band into frequency bins as a signal profile, and an FSM signal profile monitor that monitors variations signal profile according to pre-defined criteria, and outputs corresponding profile-variation information, such as with flags or interrupts.

FIG. 2 illustrates an example functional embodiment of signal profile monitoring, including capturing signal power (absolute and/or relative) into frequency bins as a signal profile, monitoring the signal profile, and providing profile-variation interrupts.

### DETAILED DESCRIPTION

This Description and the Drawings constitute a Disclosure for a signal profiler that monitors signal power per frequency band, such as can be used in a wireless receive, including example embodiments that illustrate various technical features and advantages.

The Disclosure for the signal profiler is provided in the context of a wireless receiver application, but the Disclosed signal profiler has general application to signal processing applications that can benefit from monitoring frequency band power.

In brief overview, a signal profiler generates and monitors a signal profile corresponding to signal power (absolute or relative) per frequency band. The signal profiler includes a signal profile generator and a signal profile monitor. The signal profile generator processes a received signal in pre-defined frequency bands, and captures frequency-band signal power information into frequency bins, this frequency-binned signal power information constituting a signal profile. The signal profile monitor monitors the signal profile, including variations in the signal profile based on pre-defined criteria, and output corresponding profile-variation information (such as flags or interrupt requests). The signal profile generator is an FFT engine. The signal profile monitor is an FSM (finite state machine). An example application is use in a direct conversion wireless receiver to monitor relative image channel power as a signal profile variation that can be used to invoke QMC compensation/configuration.

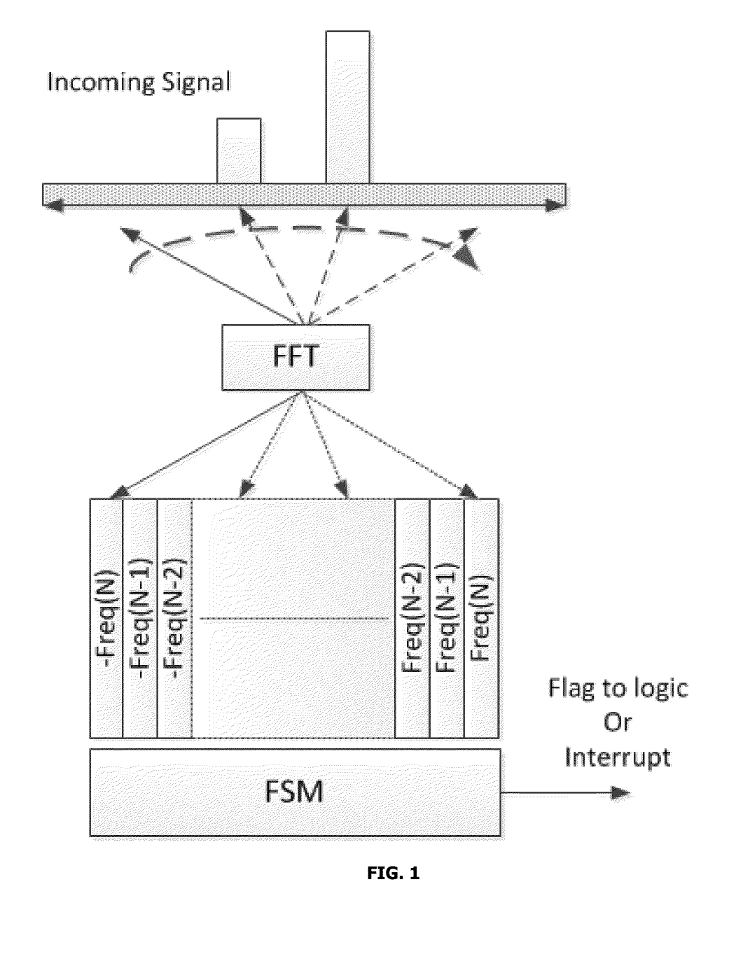

FIG. 1 illustrates an example functional embodiment of a signal profiler, such as can be used in a wireless receiver, including an FFT signal profile generator, and an FSM (finite state machine) signal profile monitor. The FFT signal profile generator (engine) that captures signal power (absolute and/or relative) per frequency band into frequency bins as a signal profile. The FSM signal profile monitor monitors variations signal profile according to pre-defined criteria, and outputs corresponding profile-variation information, such as with flags or interrupts.

For real-time tracking, the Signal Profiler monitors the signal power per frequency bin. Signal power can be captures as absolute or relative.

An FFT signal profile generator (engine) captures signal profile frequency band power information into frequency bins, which provide a signal profile.

An FSM signal profile monitor determines if the relative signal power between the desired channel and the image channel (+f vs−f) is changed by larger amount than a threshold (according to pre-defined criteria). If a signal profile variation is detected, an interrupt is issued, such as to an MPU (micro processing unit). For example, the signal profile variation can be used to rerun an IQ imbalance compensation routine.

The profiler scans the bands of interest, and captures either absolute or relative signal powers within a frequency band of interest into frequency bins, depending on pre-defined criteria. This frequency band information is referred to as a signal profile.

The design of the FFT engine is application specific. Depending on the design spec (scan time, allowed gate size etc.), either a large N-point FFT or single/M-point FFT (where M<<N) can be used.

The FSM signal profile monitor monitors variation of signal profile over time. When a pre-defined variation in signal profile is observed, a flag or an interrupt is generated so that a proper follow-up operation to be executed

The signal profile generator records absolute or relative signal power within a frequency band of interest. The band of interest is scanned to build a signal profile. Design of the FFT engine is application specific. For example, a single-point FFT can be used at the cost of scan time. Design criteria include: available silicon area, and allowed power consumption.

Variation of signal profile over time is monitored. The FFT engine scans the input signal band and record the absolute or relative power level (in approximated dB). This profile is compared over time by an FSM. When there is a relative power change which is larger than a threshold, an interrupt is generated. The MPU detects the interrupt and triggered the necessary operation (for example, QMC compensation routine)

Signal profiling enables the receiver to be able to react to dynamically changing incoming signals in a more active/agile way As shown in the example, enable DSP assisted methods to be used minimizing the burden on MPU.

For QMC, absolute power does not give enough information to determine when IQ imbalance needs to be recalibrated. While, relative power change can give a hint when needs to be calibrated again.

Hence, there is a need to develop a method to obtain frequency dependent signal profile information over the band of interest. (Two examples are shown in the attached PPT slide. (IQ imbalance compensation and AGC)).

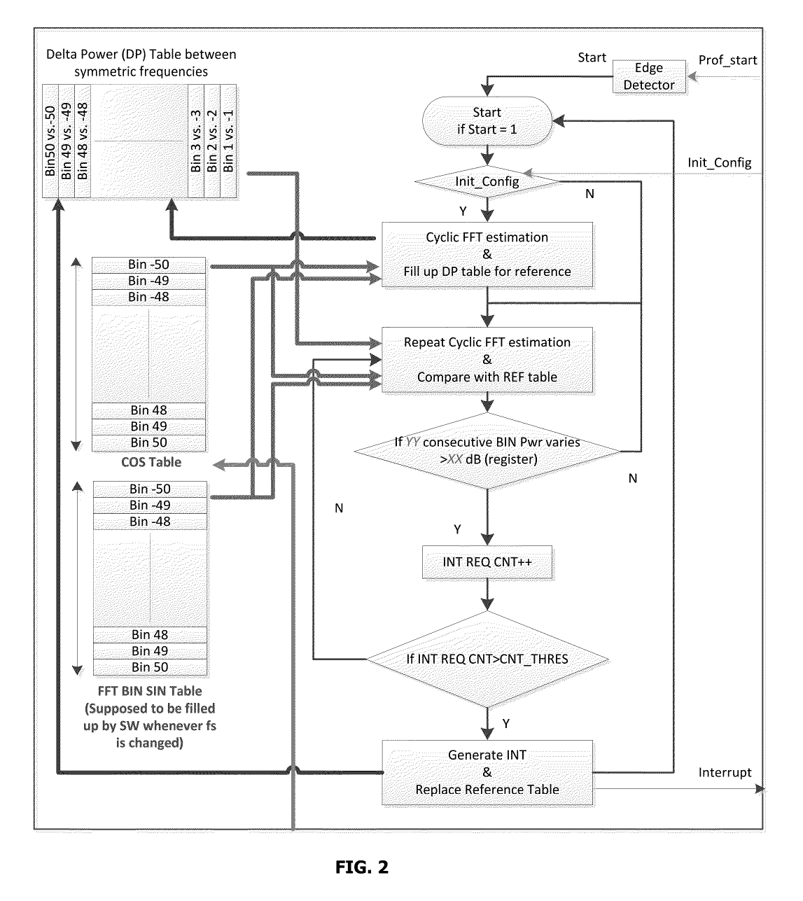

FIG. 2 illustrates an example functional embodiment of signal profile monitoring, including capturing signal power (absolute and/or relative) into frequency bins as a signal profile, monitoring the signal profile, and providing profile-variation interrupts.

For IQ mismatch tracking purpose, the relative signal power between the desired channel and the image channel (+f vs−f) is tracked over time. When the relative power change over time becomes larger than a predetermined threshold, an interrupt is generated in order for MPU to rerun IQ imbalance compensation routine.

The FFT engine is used to build the signal profile. This profile is compared over time by an FSM. FSM generates an interrupt when the large change of signal profile is detected.

Generally, RF transceiver used in infrastructure has been designed in high IF architecture. In this case, there is no need to track image rejection ratio (IRR) over time since the architecture itself guarantees free of image issue.

IRR is a critical parameter for the low-IF RF transceiver which is normally used in mobile application. But, for mobile application, much simpler adaptive algorithm is generally used since the requirement is not high. And, the algorithm is implemented in ASIC. Hence, also there is no need to have an IP similar to the proposed IP.

An example application is a wireless receiver application, such as for wireless base station, with a zero/low-IF direct conversion architecture. IRR requirement is high.

An example signal profiler application is QMC (IQ mismatch/imbalance) compensation. A wireless receiver can include QMC compensation based on a complex signal processing algorithm. The core mathematical portion of the algorithm is normally implemented in software and is very time consuming task. Hence, it is not practical for an MPU to perform a real-time tracking to determine when the algorithm needs to be re-run. And, when the core algorithm is implemented in DSP, real-time tracking is problematic.

The signal profiler provides a QMC detection method to detect when quadrature mismatch needs to be re-calibrated, including monitoring the signal power per frequency bin. For example, if the relative signal power between the desired channel and the image channel (+f vs−f) is changed by larger amount than a threshold, an interrupt is generated in order for MPU to rerun IQ imbalance compensation routine.

Another example signal profiler application is AGC. An RF receiver generally tries to maximize the SNR. In a direct conversion low-IF architecture, one of the key performance parameter are sensitivity in the existence of 1^{st} or 2^{nd} adjacent channel interference. Since the filtering on the 1^{st} or 2^{nd} adⱼacent channel interference is large, power detectors do not give much information to AGC. Hence, it is not easy for an AGC to settle down to an optimal gain settings which make the best trade-off between compression/linearity and NF. For this case, if relative power information is known between the desired signal and adjacent interferer, AGC can react in a more efficient way.

Advantages of the signal profiler include: enabling the receiver to be able to react to dynamically changing incoming signals in a more active/agile way, and enabling DSP assisted methods to be used minimizing the burden on MPU.

The Disclosure provided by this Description and the Figures sets forth example embodiments and applications illustrating aspects and features of the invention, and does not limit the scope of the invention, which is defined by the claims. Known circuits, functions and operations are not described in detail to avoid obscuring the principles and features of the invention. These example embodiments and applications can be used by ordinarily skilled artisans as a basis for modifications, substitutions and alternatives to construct other embodiments, including adaptations for other applications.

1. A signal profiler suitable for use in a wireless receiver, comprising
a signal profile generator configured to process a received signal in pre-defined frequency bands, and capture frequency-band signal power information into frequency bins, such frequency-binned signal power information constituting a signal profile;
a signal profile monitor configured to
monitor the signal profile, including variations in the signal profile based on pre-defined criteria, and
output corresponding profile-variation information.

2. The signal profiler of claim 1, wherein signal power is at least one of absolute signal power and relative signal power.

3. The signal profiler of claim 1, wherein the signal profile generator is an FFT engine.

4. The signal profiler of claim 1, wherein the signal profile monitor is an FSM (finite state machine).

5. The signal profiler of claim 1, wherein the profile-variation information is one of a flag or an interrupt request (IRQ).

6. The signal profiler of claim 1, wherein the wireless receiver is a direct conversion architecture including IQ demodulation and RF downconversion, and including QMC (IQ mismatch/imbalance compensation), and wherein the profile-variation information corresponds to a pre-defined relative difference between a desired channel and its image channel (+f vs−f), that can be used to invoke QMC compensation or QMC calibration.
